(19) United States
(12) Patent Application Publication
(10) Pub. No.: US 2023/0261495 A1
(43) Pub. Date: Aug. 17, 2023

(54) A DEVICE AND METHOD FOR CHARGING ENERGY STORAGE DEVICES

(71) Applicant: ZERO-ERROR SYSTEMS PTE. LTD., Singapore (SG)

(72) Inventors: Wei SHU, Singapore (SG); Joseph Sylvester CHANG, Singapore (SG); Kwen Siong CHONG, Singapore (SG); Arunjai MITTAL, Singapore (SG); Yong QU, Singapore (SG)

(21) Appl. No.: 18/005,163

(22) PCT Filed: Jul. 14, 2021
(86) PCT No.: PCT/SG2021/050409

§ 371 Date: Jan. 11, 2023

(30) Foreign Application Priority Data
Jul. 16, 2020 (SG) 10202006820Y

(51) Int. Cl. H02J 7/00; H01M 10/44

(52) U.S. Cl. CPC H02J 7/00712; H01M 10/44; H02J 7/0013

(57) ABSTRACT

A device that includes one or more charging circuits is disclosed. Each charging circuit includes an input for connecting to an energy source, an output for connecting to an energy storage device, a signal generator and a switching circuit. The signal generator is configured to generate a control signal that includes enabling and disabling signal portions having a duty cycle that is based on an output voltage at the output. The switching circuit is configured to alternately couple the output to the input and a ground during the enabling signal portions of the control signal, and to isolate the output from the input and the ground during the disabling signal portions of the control signal. A method of charging an energy storage device is also disclosed.

### TECHNICAL FIELD

Embodiments of the invention generally relate to a device and a method for charging energy storage devices. More particularly, the embodiments relate to a device and a method for charging energy storage devices over a constant current charging phase and a constant voltage charging phase.

### BACKGROUND

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

A charger circuit for energy storage devices serves to deliver regulated current, voltage or current and voltage (power) during different charging phases to charge the energy storage devices.

State-of-the-art energy storage devices (e.g., lithium-ion battery) typically require various charging phases including a number of Constant Current (CC) charging phases and a Constant Voltage (CV) charging phase. The Constant Current (CC) charging phases include a Trickle-charging phase, a Pre-charging phase and a Fast CC charging phase. The different charging phases require different output currents and/or voltages. In view of this, chargers typically require different control modes to cater to the needs of the different charging phases.

In a known switched-mode charger 10 shown in FIG. 1, V_{IN} 101 and I_{IN} 102 are an input charging source voltage and an input charging source current respectively. V_{OUT} 103 and I_{OUT} 104 are an output charging voltage and an output charging current respectively. C_{IN} 105 and C_{O} 106 are an input capacitor and an output capacitor respectively; and V_{C} 112 is a control signal for an output stage 111.

FIG. 2 depicts an example of the output stage 111 of the switched-mode charger 10. The output stage 111 includes two switching devices SW1 1111 and SW2 1112. These switching devices 1111, 1112 include, but are not limited to, transistors, diodes, etc. The output stage 111 generates two control signals, V_{SW1} 1115 and V_{SW2} 1116, based on the control signal V_{C} 112 for respectively controlling the ‘ON’ and/or ‘OFF’ of the two switching devices, SW1 1111 and SW2 1112.

FIG. 3 depicts the waveforms of the switched-mode charger 10 with a control methodology at different charging phases 2-8. When the energy storage device 104 being charged is very weak (exhausted or near-exhausted), i.e., V_{OUT} 103 is lower than a threshold voltage_1 V_{TH1}, which is a manufacturer recommended parameter for the energy storage device 104, a Trickle Charge mode is enabled and the switched-mode charger 10 outputs a constant low current I_{OUT} 104 whose value is given by k₁×I_{CHG}; where k₁<1 and I_{CHG} is the full charging current. When V_{OUT} 103 increases to greater than the threshold voltage_1 V_{TH1} but lower than a threshold voltage_2 V_{TH2}, a Pre-Charge mode is enabled and the switched-mode charger 10 outputs a constant current I_{OUT} 104 that is slightly higher than that in the Trickle Charge mode, i.e. the value of this higher current is now k₂×I_{CHG}; where k₁<k₂<1. In both the Trickle Charge mode and Pre-Charge mode, the control signal V_{C} 112 is obtained from the Trickle and Pre-Charge Mode Controller 113 via closing of a switch S₁ 108, and the switched-mode charger 10 operates in a Discontinuous Conduction CC Mode.

When V_{OUT} 103 increases to greater than the threshold voltage_2 V_{TH2} but lower than a threshold voltage_3 V_{TH3}, a Fast Constant Current (CC) Charge mode is enabled and the switched-mode charger 10 outputs a constant maximum current I_{OUT} 104 having a value of 100%×I_{CHG}. In this mode, the control signal V_{C} 112 is obtained from the Fast CC Mode Controller 114 via closing of a switch S₂ 109, and the switched-mode charger 10 operates in a Continuous Conduction CC Mode. When the energy storage device 104 is almost full (fully-charged), i.e., V_{OUT} 103 is at or greater than the threshold voltage_3 V_{TH3}, a Constant Voltage (CV) Charge mode is enabled and the switched-mode charger 10 outputs a constant maximum voltage V_{MAX}. In this mode, the control signal V_{C} 112 is obtained from the CV Mode Controller 115 via closing of a switch S₃ 110, and the switched-mode charger 10 operates in a Discontinuous Conduction CV Mode. In all the charging modes, the control signal V_{C} 112 is a continuous analog signal. The control signal V_{C} 112 is at a different substantially constant level for the Trickle Charge, Pre-Charge and Fast CC Charge modes. The two control signals, V_{SW1} 1115 and V_{SW2} 1116 for turning on and off of the switching devices 1111, 1112 are generated in the output stage 111 based on the level of the control signal V_{C} 112. The control signals 1115, 1116 include pulses for alternately closing the switching devices 1111, 1112. The pulse widths and/or periods of the control signals 1115, 1116 are dependent on the level of the control signal V_{C} 112.

From FIG. 1, FIG. 2, and FIG. 3, it can be seen that the control methodology requires multiple controllers 113, 114, 115 (with different design specifications) to achieve multiple charging modes and hence the pertinent charging requirements. As such, it suffers from four major shortcomings. Firstly, the control methodology generally requires dedicated control circuitries for the different charging modes, hence requiring complicated hardware (e.g., requiring complex stability compensation). This leads to inevitable compromised dynamic performance particularly at transitions from one charging mode to another. Secondly, the power-efficiency of the control methodology varies substantially at different charging modes because the operations of the charging modes are very different. Further, it is impossible to optimize the power-efficiency across all charging modes as most, if not all, of the external components are shared amongst all charging modes. Thirdly, the Bill of Materials (BoM) is high because the control methodology imposes strict requirements for the selection of discrete components (i.e., inductor and capacitor). Fourthly, its form factor is large because the required inductor is relatively large and compensation networks are complicated.

There is therefore a need for a switch-mode charging device which addresses, at least in part, one or more of the forgoing problems.

### SUMMARY

According to an aspect of the present disclosure, there is provided a device that includes one or more charging circuits. Each charging circuit includes an input for connecting to an energy source, an output for connecting to an energy storage device, a signal generator and a switching circuit. The signal generator is configured to generate a control signal that includes enabling and disabling signal portions having a duty cycle that is based on an output voltage at the output. The switching circuit is configured to alternately couple the output to the input and a ground during the enabling signal portions of the control signal, and to isolate the output from the input and the ground during the disabling signal portions of the control signal.

In some embodiments, the output has a low impedance during the enabling signal portions of the control signal and a high impedance during the disabling signal portions of the control signal.

In some embodiments, the control signal has a first duty cycle when the output voltage is lower than a first threshold, and a second duty cycle when the output voltage is higher than the first threshold. The second duty cycle may be higher or lower than the first duty cycle.

In some embodiments, the control signal has the second duty cycle when the output voltage is higher than the first threshold and lower than a second threshold, and a third duty cycle when the output voltage is higher than the second threshold and lower than a third threshold. The third duty cycle may be close to one or one.

In some embodiments, the third threshold is close to or same as a maximum voltage of the energy storage device, and the control signal has a decreasing duty cycle when the output voltage reaches the third threshold.

In some embodiments, the width of each enabling signal portion corresponds to at least one cycle of coupling the output to the input and then to the ground.

In some embodiments, the device further comprises two or more input switches, wherein one of the input switches is configured to couple the input to the energy source, and each of the remaining input switches is configured to couple the input to a respective another energy source.

In some embodiments, the device alternatively or additionally includes two or more output switches. One output switch is configured to couple the output to the energy storage device. Each of the remaining output switches is configured to couple the output to a respective another energy storage device.

In some embodiments, the device comprises two or more charging circuits having respective outputs that are coupled together.

In some embodiments, the switching circuit operates under a first operation mode to alternately couple the output to the input and the ground during the enabling signal portions of the control signal; and isolate the output from the input and the ground during the disabling signal portions of the control signal. The switching circuit is further configured, under a second operation mode, to alternately couple the input to the output and the ground during the enabling signal portions of the control signal; and to isolate the input from the output and the ground during the disabling signal portions of the control signal.

According to another aspect of the present disclosure, there is provided a method of charging an energy storage device. The method includes generating a control signal that includes enabling and disabling signal portions having a duty cycle that is based on a voltage of the energy storage device; alternately coupling the energy storage device to an energy source and a ground during the enabling signal portions of the control signal; and isolating the energy storage device from the energy source and the ground during the disabling signal portions of the control signal.

In some embodiments, the control signal has a first duty cycle when the voltage of the energy storage device is lower than a first threshold, and a second duty cycle when the voltage of the energy storage device is higher than the first threshold. The second duty cycle may be higher or lower than the first duty cycle.

In some embodiments, the control signal has the second duty cycle when the voltage of the energy storage device is higher than the first threshold and lower than a second threshold, and a third duty cycle when the voltage of the energy storage device is higher than the second threshold and lower than a third threshold. The third duty cycle may be close to one or one.

In some embodiments, the third threshold is close to or the same as a maximum voltage of an energy storage device, and wherein the control signal has a decreasing duty cycle when the voltage of the energy storage device reaches the third threshold.

In some embodiments, the width of each enabling signal portion corresponds to one or more cycles of coupling the energy storage device to the energy source and then to the ground.

In some embodiments, the energy source is at least one energy source selectable from multiple energy sources.

In some embodiments, the energy storage device is at least one energy storage selectable from multiple energy storage devices.

In some embodiments, the energy source outputs a voltage, a current or both voltage and current, and the energy storage device receives a voltage, a current or both voltage and current.

In some embodiments, alternately coupling the energy storage device to an energy source and a ground during the enabling signal portions of the control signal; and isolating the energy storage device from the energy source and the ground during the disabling signal portions of the control signal are performed under a first operation mode. The method, under a second operation mode, further includes alternately coupling the energy source to the energy storage device and the ground during the enabling signal portions of the control signal; and isolating the energy source from the energy storage device and the ground during the disabling signal portions of the control signal.

This summary does not describe an exhaustive list of all aspects of the present invention. It is anticipated that the present invention includes all methods, apparatus and systems that can be practiced from all appropriate combinations and permutations of the various aspects in this summary, as well as that delineated below. Such combinations and permutations may have specific advantages not specially described in this summary.

### BRIEF DESCRIPTION OF FIGURES

In order that the invention may be fully understood and readily put into practical effect, there shall now be described by way of non-limitative example only exemplary embodiments of the present invention, the description being with reference to the accompanying illustrative drawings.

FIG. 1 is a schematic diagram of the switched-mode charger with a control methodology.

FIG. 2 is an example of an output stage of the switched-mode charger in FIG. 1.

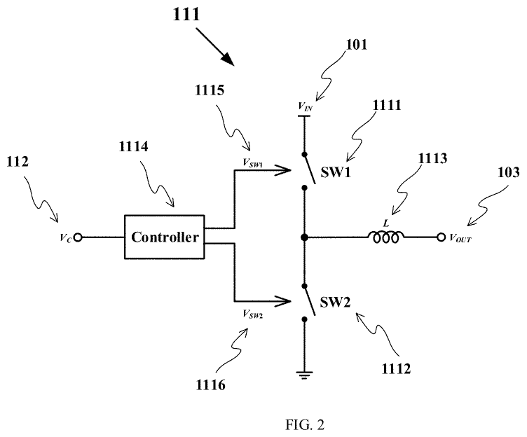

FIG. 3 is the operational waveforms of the switched-mode charger in FIG. 1.

FIG. 4 is a schematic diagram of a switched-mode charger having a control circuity and an output stage, according to an embodiment of the invention.

FIG. 5 is a schematic diagram of the control circuitry in FIG. 4 according to one embodiment of the invention.

FIG. 6 is a schematic diagram of the output stage in FIG. 4 according to one embodiment of the invention.

FIG. 7 shows waveforms of the switched-mode charger in FIG. 4.

FIG. 8 is a schematic diagram of a switched-mode charger that receives power from multiple energy sources according to another embodiment of the invention.

FIG. 9 shows operational waveforms of the switched-mode charger in FIG. 8 during a Fast CC Charge phase.

FIG. 10 is a schematic diagram of a switched-mode charger that receives power from multiple energy sources for charging multiple energy storage devices according to a further embodiment of the invention.

FIG. 11 is a schematic diagram of a switched-mode charger having outputs of multiple chargers in FIG. 10 connected together according to yet another embodiment of the invention.

Other aspects and advantages of the invention will become apparent from the following detailed description, taken in conjunction with the accompanying drawings, illustrating by way of example the principles of the invention.

### DETAILED DESCRIPTION

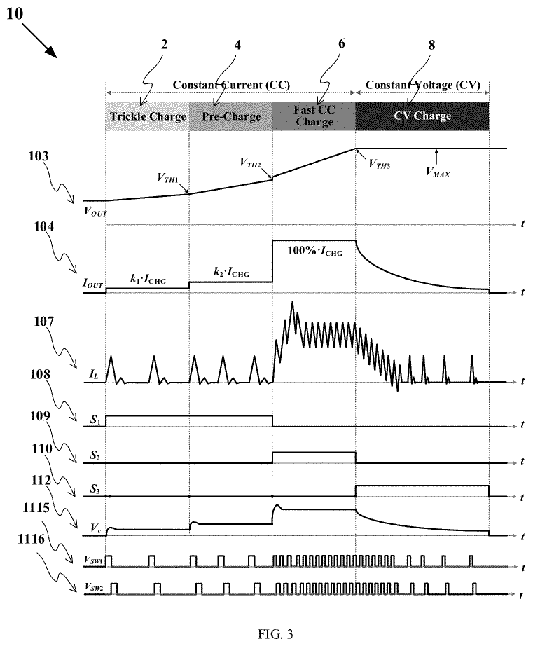

Exemplary embodiments of the control methodology or circuitry for the switched-mode charger will be described below with reference to FIGS. 3 to 9 below. Numerous specific details are set forth in the following description. It is however understood that embodiments of the invention may be practiced with or without these specific details. In other instances, circuits, structures, methods and techniques that are known are not included so as to avoid obscuring the understanding of this description. Furthermore, the following embodiments of the invention may be described as a process, which may be described as a flowchart, a flow diagram, a structure diagram, or a block diagram. The operations in the flowchart, flow diagram, structure diagram or block diagram may be a sequential process, parallel or concurrent process, and the order of the operations may be re-arranged. A process may correspond to a technique, methodology, procedure, etc.

Throughout this document, unless otherwise indicated to the contrary, the terms “comprising”, “consisting of”, “having” and the like, are to be construed as non-exhaustive, or in other words, as meaning “including, but not limited to.”

Furthermore, throughout the specification, unless the context requires otherwise, the word “include” or variations such as “includes” or “including” will be understood to imply the inclusion of a stated integer or group of integers but not the exclusion of any other integer or group of integers.

Throughout the description, it is to be appreciated that the term ‘controller’ and its plural form include microcontrollers, microprocessors, programmable integrated circuit chips such as application specific integrated circuit chip (ASIC), computer servers, electronic devices, and/or combination thereof capable of processing one or more input electronic signals to produce one or more output electronic signals. The controller includes one or more input modules and one or more output modules for processing of electronic signals.

Unless defined otherwise, all technical and scientific terms used herein have the same meaning as is commonly understood by a skilled person to which the subject matter herein belongs.

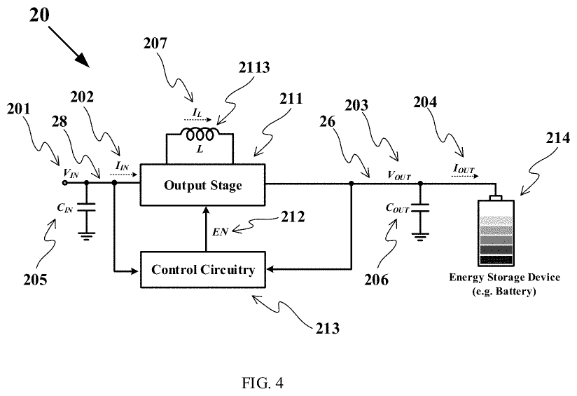

As shown in the drawings for purposes of illustration, the invention may be embodied in a novel device and method for charging an energy storage device, such as a battery. Existing devices tend to be complicated and costly. Referring to FIGS. 4-7, a device embodying the invention generally includes one or more charging circuits. Each charging circuit includes an input for connecting to an energy source, an output for connecting to an energy storage device, a signal generator and a switching circuit. The signal generator is configured to generate a control signal that includes enabling and disabling signal portions having a duty cycle that is based on an output voltage of the output. The switching circuit is configured to alternately couple the output to the input and a ground during the enabling signal portions of the control signal, and to isolate the output from the input and the ground during the disabling signal portions of the control signal. The device may be a charging device, an integrated circuit or a printed circuit board, etc.

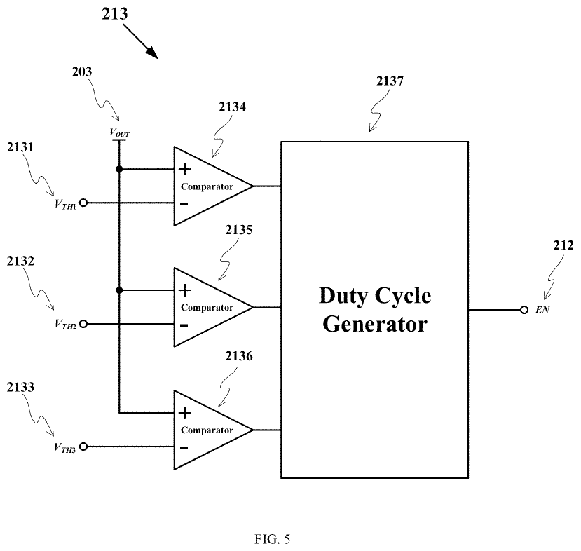

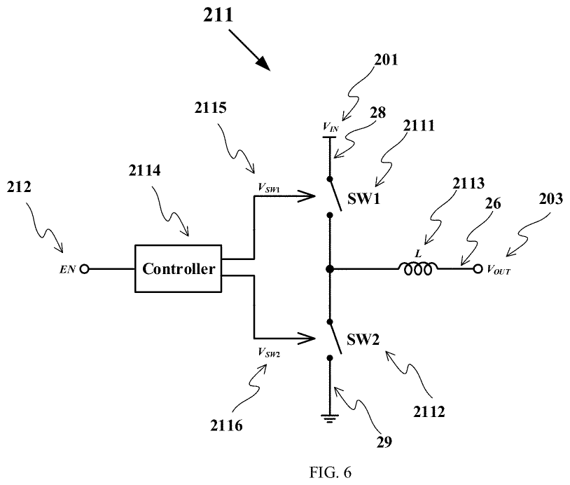

Specifically, FIG. 4 depicts a first exemplary embodiment of a device that functions as a switched-mode charger 20 having a signal generator or control circuity 213 and a switching circuit or output stage 211. FIG. 5 shows components of the control circuity 213 and FIG. 6 shows components of the output stage 211. The control circuity 213 receives an output voltage 203 and generates a control signal EN 212. This control signal 212 includes enabling signal portions 22 and disenabling signal portions 24. In this embodiment, an enabling signal portion 22 has a high voltage level while a disabling signal portion 22 has a low voltage level. However, the reverse is also possible. That is, an enabling signal portion 22 may be of a low voltage level while the disabling signal portion 24 may be of a high voltage level. The duty cycle of the control signal 212 is given by a width of the enabling signal portion 22 over a combined width of the enabling signal portion 22 and adjacent disabling signal portion 24. In other words, the control circuitry 213 outputs ‘Enable’ or ‘Disable’ signals. When the control signal EN 212 is ‘Enable’ (enabled), the output stage 211 alternately couples an output 26, via an inductive element such as, but not limited to, an inductor L 2113, to an input 28 and a ground 29. In this enabled state, the impedance at the output 26 of the output stage 211 is low. In this state, the output 26 of the output stage 211 is either connected to ground by the closing of a switching device 2112 or to a DC (or near-DC) energy source or power supply by closing a switching device 2111. The switching devices 2111, 2112 include, but are not limited to, transistors, MOSFETS, diodes, or the like known to those skilled in the art. When the control signal EN 212 is ‘Disable’ (disabled), the output stage 211 isolates the output 26 from the input 28 and the ground 29 by turning off both the switching devices 2111, 2112. In this disabled state, the impedance of the output of output stage 211 is high.

In the ‘Enable’ state, the output stage 211 operates at a high or maximum (or near-maximum) power-efficiency point to output current and/or voltage to charge an energy storage device 214. Conversely, in the ‘Disable’ state, the output stage 211 outputs zero (or near-zero) current and/or voltage to the energy storage device 214. The duty-cycle of the ‘Enable’ and ‘Disable’ largely determines an actual output charging current and/or voltage.

FIG. 5 depicts one embodiment of the control methodology or circuitry 213. The control circuitry 213 receives the output voltage V_{OUT} 203 and compares it with three threshold voltages, V_{TH1} 2131, V_{TH2} 2132 and V_{TH3} 2133 using three respective comparators 2134, 2135 and 2136. The threshold voltages V_{TH1} 2131, V_{TH2} 2132 and V_{TH3} 2133 are typically determined by a manufacturer of the energy storage device 214. Based on the outputs of these three comparators 2134, 2135 and 2136, a duty cycle generator 2137 generates the control signal EN 212. The control signal 212 may be an analogue or a digital signal. When the control signal 212 is an analog signal, the enabling signal portions 22 and the disabling signal portions 24 may be of different voltage levels as described above. The duty cycle of the control signal EN 212 is selected so as to produce the actual output current or voltage required in the different charging phases.

The schematic drawing in FIG. 5 shows one way of implementing the control methodology or circuitry 213. There are other ways of implementing the control circuitry 213. As an example, the comparison and the ensuing duty cycle generator in FIG. 5 can be implemented using a microcontroller in digital realization instead of the analog realization shown in FIG. 5.

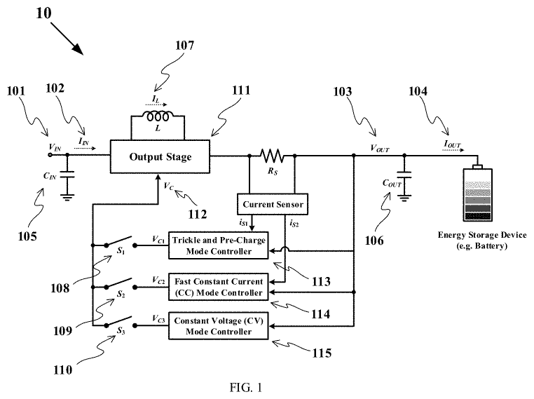

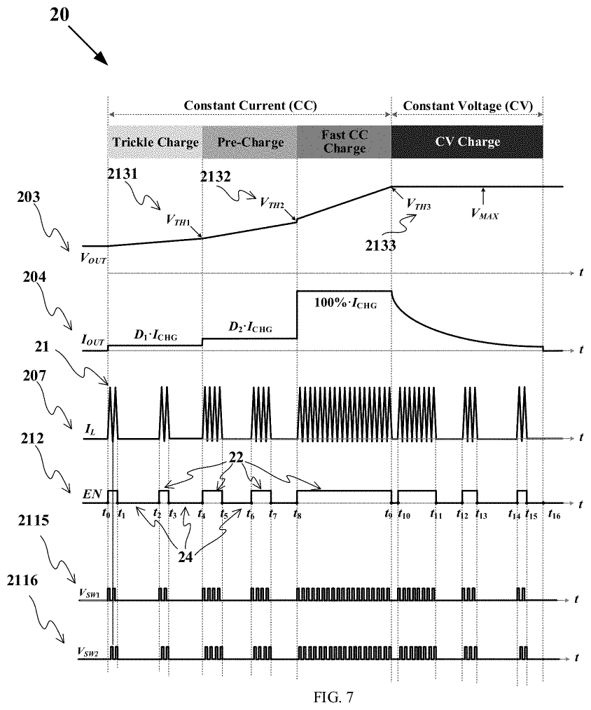

FIG. 6 depicts one embodiment of the output stage 211, wherein switching devices SW1 2111 and SW2 2112 can be implemented using any switching devices such as, but not limited to, transistors, diodes, etc. Based on the control signal EN 212 received, the output stage 211 generates two control signals V_{SW1} 2115 and V_{SW2} 2116 for turning ‘ON’ and ‘OFF’ the two switching devices SW1 2111 and SW2 2112. Unlike the control signal V_{C} 112 in FIG. 1, the control signal EN 212 is a bi-level signal in a one or more of the charging phases. When the control signal EN 212 is at a high voltage level, the output stage 211 of the switched-mode charger 20 is enabled, wherein the controller 2114 produces pulses for alternately turning on of the two switching devices SW1 2111 and SW2 2112. The controller 2114 can be implemented in many ways known to those skilled in the art. One possible implementation is to use combinational logic, such as logic AND gates (not shown), with the control signal EN 212 functioning as a gating signal at an input thereof to obtain the two control signals 2115, 2116 at outputs of the logic AND gates. The pulse width of the control signal 212 is determined based on a peak value 21 of an inductor current I_{L} 207. The alternating pulses define the two control signals V_{SW1} 2115 and V_{SW2} 2116. At any one time during an enabling signal portion 22, only one of the two switching device SW1 2111 and SW2 2112 is turned on. In other words, the switching device SW1 2111 is turned on and the switching device SW2 2112 is turned off during a first time slot, and the switching device SW1 2111 is turned off and the switching device SW2 2112 is turned on during a second time slot following the first time slot. At no time are both the switching devices SW1 2111 and SW2 2112 turned on simultaneously. In this manner, the output stage 211 alternately couples the output 26 to the input 28 and ground 29. The width of each enabling signal portion 22 corresponds to at least one complete charging cycle of coupling the output 26 to the input 28 and then to ground 29. In the embodiment shown in FIG. 7, the width of the enabling signal portion 22 in the Trickle Charge phase corresponds to two complete charging cycles of coupling the output 26 to the input 28 and then to ground 29 as shown between t₀ and t₁ in FIG. 7. And the width of the enabling signal portion 22 in the Pre-Charge phase corresponds to four cycles of coupling the output 26 to the input 28 and then to ground 29 as shown between t₄ and t₅ in FIG. 7. When the control signal EN 212 is low, the output stage 211 of the switched-mode charger 20 is disabled, and the controller 2114 turns ‘OFF’ both the switching devices SW1 2111 and SW2 2112 so that the output 26 is isolated from the input 28 and the ground 29.

Again FIG. 6 shows only one way of implementing the output stage 212 and the interconnections with the inductor L 2113. Depending on the applications and requirements, the output stage 212 can be realized with more or fewer switching devices, and the interconnections between the switching devices and the inductor L 2113 may have many variations known to those skilled in the art.

FIG. 7 depicts the waveforms of the first exemplary embodiment of the switched-mode charger 20 with the control methodology or circuitry 213. As described above, when the control signal EN 212 is high, the output stage 211 of the switched-mode charger 20 is enabled. When the control signal EN 212 is low, the output stage 211 of the switched-mode charger 20 is disabled. When the control output EN 212 is high, the inductor current I_{L} 207 increases from zero to the predetermined peak current 21 and then back to zero in accordance with the pulses of the control signals 2115, 2116. The predetermined peak current 21 is a fixed current for all charging phases shown in FIG. 7. However, this is not to be construed to be limited as such. The peak current may vary across different charging phases. For example, the peak current can be set to a high value for high-current charging modes (e.g. Fast CC) and to a low value for low-current charging modes (e.g. Trickle Charge, Pre-Charge, CV Charge).

The charging operation in FIG. 7 is next described in detail. When the energy storage device 214 is very weak, i.e. near-exhaustion or is exhausted, i.e., when V_{OUT} 203 is lower than the threshold voltage V_{TH1} 2131, the switched-mode charger 20 will be in a Trickle Charge mode. The duty cycle of the control signal EN 212, hence the duty cycle of I_{L} 207, is D₁, i.e., the ratio of the duration of ‘Enable’ divided by the duration of (‘Enable’+Disable’) is equal to D₁; where D₁<1. As a result, the magnitude of the output current I_{OUT} 204 is equal to D₁×I_{CHG}, where I_{CHG} is the full or near-full charging current.

When the energy storage device 214 is slightly charged or not quite exhausted, the output voltage V_{OUT} 203 increases to greater than the threshold voltage V_{TH1} but lower than the threshold voltage V_{TH2} 2132, the switched-mode charger will move to a Pre-Charge mode. The duty cycle of the control signal EN 212, and hence the duty cycle of I_{L} 207, is tuned to D₂, i.e., the ratio of the duration of ‘Enable’ divided by the duration of (‘Enable’+Disable’) is equal to D₂; where D₁<D₂<1. As a result, the magnitude of the output current I_{OUT} 204 is equal to D₂×I_{CHG}.

When the output voltage V_{OUT} 203 continues to increase to greater than the threshold voltage V_{TH2} but lower than the threshold voltage V_{TH3} 2133, the switched-mode charger 20 next moves to a Fast CC (Constant Current) Charge mode. The duty cycle of the control signal EN 212, and hence the duty cycle of I_{L} 207, is tuned close to or at 100%, i.e., the ratio of the duration of ‘Enable’ divided by the duration of (‘Enable’+Disable’) is equal or nearly equal to 1. As a result, the magnitude of I_{OUT} 204 is maximum or near-maximum, i.e., equal or approximately equal to 100%×I_{CHG}.

In all the three constant current (CC) or near-constant current charging modes, i.e. the Trickle Charge, the Pre-Charge and the Fast CC Charge modes, the switched-mode charger 20 charges the energy storage device 214 in a Boundary Conduction CC mode. When the energy storage device 214 is almost fully charged, i.e., the output signal V_{OUT} 203 reaches the threshold voltage V_{TH3}, the switched-mode charger 20 will go into a constant voltage (CV) Charge mode. The duty cycle of the control signal EN 212, and hence the duty cycle of I_{L} 207, is adaptively adjusted so as to maintain the output voltage V_{OUT} 203 near constant or constant at V_{TH3}=V_{MAX}. In FIG. 7, the duty cycle may be decreased in the CV charge phase to do so. In this mode, the switched-mode charger 20 charges the energy storage device 214 in a Boundary Conduction CV mode.

It can be seen from FIGS. 4-7 that the output stage 211, when ‘Enabled’, features the Boundary Conduction operation (by means of the control methodology or circuitry 213) across all charging modes. In view of this, the power-efficiency of the switched-mode charger 20 can be optimized for all charging modes, and inherent stability can be easily achieved. Further, charging mode transition is seamlessly controlled by the one bi-level control signal EN 212 for all four charging modes.

By leveraging on the control methodology (or circuitry 213) and the ensuing operation, the power efficiency of the switched-mode charger can be further enhanced by realizing fully soft-switching, i.e., Zero-Current-Switching (ZCS) and/or Zero-Voltage-Switching (ZVS).

The actual charging current obtainable can be adjusted by changing the peak current I_{L} 21, and the pertinent duty cycles D₁ and D₂.

The control methodology offers two additional merits over known methods. First, the control methodology alleviates the requirements of the discrete components in view of the ‘Enable’ and ‘Disable’ bi-level control signal 212. Hence, the cost of the discrete components can be several times lower than those used in the charger shown in FIG. 1. Second, the form factor of the switched-mode charger 20 can be much smaller due to the simpler hardware and reduced/relaxed requirements for the discrete components.

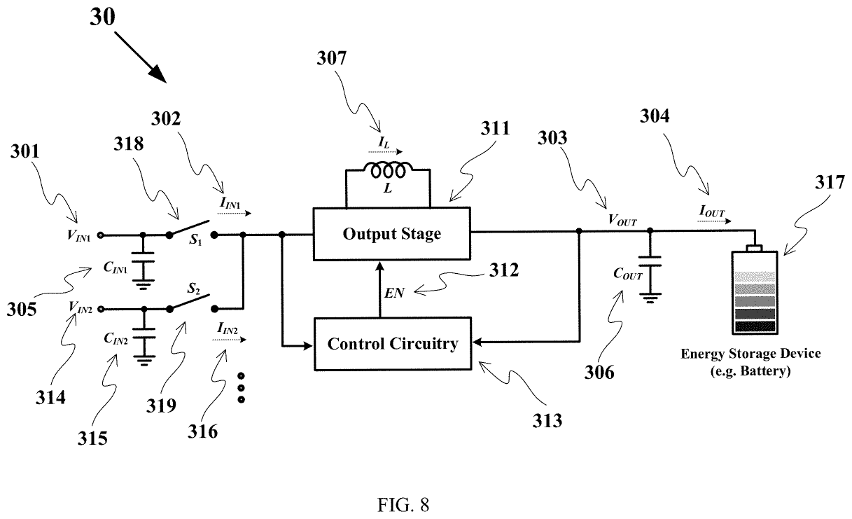

FIG. 8 depicts a switched-mode charger 30 according to a second exemplary embodiment, with the control methodology or circuitry 313, configured to be connectable to multiple energy sources, V_{IN1} 301, V_{IN2} 314, etc. These energy sources include, but are not limited to, universal serial bus (USB) adaptors and embedded wireless power receivers. This allows for the combined higher current, voltage or both current and voltage (i.e. power) to charge the energy storage device(s) 317.

In FIG. 8, two input switches S₁ 318 and S₂ 319 operate in a time-interleaved fashion, and there is one switch that is closed and hence one energy source that is connected to the switched-mode charger 30 at any one time. The timing of S₁ 318 and S₂ 319 can be determined by the electrical characteristics (e.g. available energy, output voltage, internal impedance, etc.) of each energy source or by the priority set by users, and controlled by a microcontroller. In other embodiments, both input switches S₁ 318 and S₂ 319 may be turned on at the same time so that both energy sources 301, 304 are connected to the input 28.

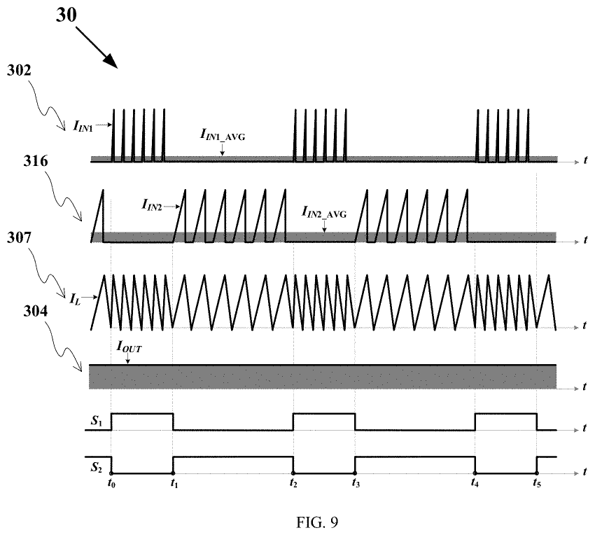

FIG. 9 depicts the operational waveforms of the second exemplary embodiment of the switched-mode charger 30 during a Fast CC Charge mode. Power from the energy source V_{IN1} 301, the energy source V_{IN2} 314, etc., are individually fed into the output stage of the switched-mode charger 30 by their respective PWM (Pulse Width Modulation) control signal for turning on input switches S₁ and S₂. When the control signal to S₁ is high, some I_{IN1} 302 current flows from V_{IN1} 301 into the output stage 311 of the switched-mode charger 30, and conversely, when the control signal to S₂ is high, some I_{IN2} 316 current flows from V_{IN2} 314 into output stage 311 of the switched-mode charger 30. The control circuitry 313 of the switched-mode charger 30 independently controls the current or energy flow from the respective energy source to the energy storage device(s) 317. The inductor current I_{L} 307 is the combined input current of I_{IN1} 302 and I_{IN2} 316. As a result, the output current I_{OUT} 304 is constant or near-constant. Ideally excluding the power loss introduced by the switched-mode charger 30 itself, P_{OUT}=P_{VIN1}+P_{VIN2}, where P_{OUT} is the total output power flowing into the energy storage device 317, P_{VIN1} is the input power from V_{IN1}, and P_{VIN2} is the input power from V_{IN2}.

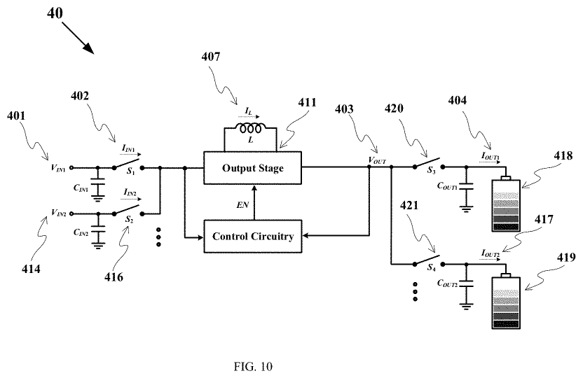

FIG. 10 depicts a switched-mode charger 40 according to a third exemplary embodiment with the control methodology or circuitry 413, configured to be connectable to multiple energy sources, V_{IN1} 401, V_{IN2} 414, etc., for charging multiple energy storage devices 418, 419, etc. The function of the input switches S₁ 402 and S₂ 416 in this figure are the same as those shown in FIG. 8. Turning on of output switches (transistors or switch-equivalents) S₃ 420 and S₄ 421, are time-interleaved to distribute the output current from the switched-mode charger 40 to the energy storage devices 418 and 419, etc., with pertinent output currents, I_{OUT1} 404, I_{OUT2} 417, etc. The timing for turning S₃ 420 and S₄ 421 on and off can be determined by the electrical characteristics (e.g. available energy, output voltage, internal impedance, etc.) of each energy storage device or according to a sequence set by users, and can be controlled using a microcontroller. In other embodiments, both output switches S₃ 420 and S₄ 421 may be turned on to charge the energy storage devices 418, 419 simultaneously. In other words, the switched-mode charger 40 may be used in a one-to-one configuration wherein a single energy source is used to charge a single energy storage device, a one-to-many configuration wherein a single energy source is used to charge multiple energy storage devices, a many-to-one configuration wherein multiple energy sources are used to charge a single energy storage device or a many-to-many configuration wherein multiple energy sources are used to charge multiple energy storage devices.

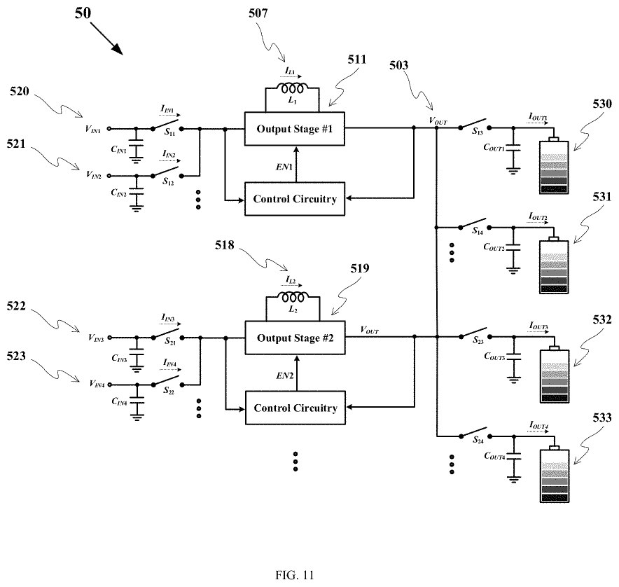

FIG. 11 depicts switched-mode charger 50 according to a fourth exemplary embodiment. This switched-mode charger 50 includes multiple switched-mode chargers 40, shown in FIG. 10. The output of the switched-mode chargers 40 are connected together. This switched-mode chargers 50 is configured to be connectable to multiple energy sources, V_{IN1} 520, V_{IN2} 521, V_{IN1} 522, V_{IN2} 523, etc., for charging multiple energy storage devices 530, 531, 532, 533, etc. Each switched-mode charger 40 is self-regulated, and multiples of them may be arranged in parallel to output the combined current or power to charge multiple energy storage devices 530, 531, 532, 533, etc.

The switched-mode chargers shown in FIG. 4, FIG. 8, FIG. 10 and FIG. 11 may operate in a first operation mode as described above where the energy source is used to charge the energy storage device. In other embodiments, each switched-mode charger may be configurable for bi-directional charging. That is, the switched-mode charger may be configured to operate in a second operation mode when there is a need to transfer energy from the energy storage device(s) on the right to the energy source(s) on the left. The control circuitry 213 can be configured to control the direction of energy flow accordingly. In the second operation mode, the configuration can be realized by sensing the input voltage V_{IN} instead of the output voltage V_{OUT} as described above for generating the control signal 212. The control methodology described above for the switched-mode chargers shown in FIG. 4, FIG. 8, FIG. 10 and FIG. 11 remains unchanged. To provide this bi-directional charging, the control circuitry 213 generates the same control signal 212 that includes enabling and disabling signal portions 22, 24 but having a duty cycle that is based on a voltage at the input 28 instead. The output stage 211 alternately couples the input 28 to the output 26 and the ground 29 during the enabling signal portions 22 of the control signal 212 and isolates the input 28 from the output 26 and the ground 29 during the disabling signal portions 24 of the control signal 212.

Accordingly, each of the above-described switched-mode chargers 20 implements a method of charging one or more energy storage devices 214. The method includes generating a control signal 212 that includes enabling and disabling signal portions having a duty cycle that is based on a voltage 203 of an energy storage device 214 being charged; alternately coupling the energy storage device 214 to an energy source and a ground during the enabling signal portions of the control signal; and isolating the energy storage device 214 from the energy source and the ground during the disabling signal portions of the control signal 212.

Alternately coupling the energy storage device 214 to a energy source and the ground may include alternately coupling the energy storage device via an inductive element, such as but not limited to an inductor L, to the energy source and the ground during the enabling signal portions of the control signal 212.

The control signal may have a first duty cycle when the voltage 203 of the energy storage device 214 is lower than a first threshold 2131, and a second duty cycle when the voltage of the energy storage device is higher than the first threshold 2131. The second duty cycle is may be higher or lower than the first duty cycle.

The control signal 212 may have the second duty cycle when the voltage 203 of the energy storage device 214 is higher than the first threshold 2131 and lower than a second threshold 2132, and a third duty cycle when the voltage 203 of the energy storage device 214 is higher than the second threshold 2132 and lower than a third threshold 2133. The third duty cycle may be close to one or one.

The third threshold 2133 may be close to or is a maximum voltage of an energy storage device 214. The control signal 212 may have a decreasing duty cycle when the voltage 203 of the energy storage device 214 reaches the third threshold 2133.

The width of each enabling signal portion corresponds to one or more complete charging cycles of coupling the energy storage device 214 to the energy source and then to the ground.

In some embodiments, the energy source is at least one energy source selectable from multiple energy sources.

And in some embodiments, the energy storage device 214 is at least one energy storage devices selectable from multiple energy storage devices.

Although the present invention is described as implemented in the above-described embodiments, it is not to be construed to be limited as such. For example, although it is described that there are four separate charging phases, there may be more or less than four charging phases.

As another example, the control circuitry 213 in FIG. 4 may be used in an embodiment to replace one or more of the controllers 113, 114 and 115.

Whilst there has been described in the foregoing description exemplary embodiments of the present invention, it will be understood by those skilled in the technology concerned that many variations and combination in details of design, construction and/or operation may be made without departing from the present invention.

1. A device comprising at least one charging circuit, wherein each of the at least one charging circuit comprises:
an input for connecting to an energy source;
an output for connecting to an energy storage device;
a signal generator configured to generate a control signal that includes enabling and disabling signal portions having a duty cycle that is based on a voltage at the output; and
a switching circuit configured to:
alternately couple the output to the input and a ground during the enabling signal portions of the control signal; and
isolate the output from the input and the ground during the disabling signal portions of the control signal.

2. A device according to claim 1, wherein the output has a low impedance during the enabling signal portions of the control signal and a high impedance during the disabling signal portions of the control signal.

3. A device according to claim 1, wherein the control signal has a first duty cycle when the output voltage is lower than a first threshold, and a second duty cycle when the output voltage is higher than the first threshold.

4. A device according to claim 3, wherein the control signal has the second duty cycle when the output voltage is higher than the first threshold and lower than a second threshold, and a third duty cycle when the output voltage is higher than the second threshold and lower than a third threshold.

5. A device according to claim 4, wherein the third threshold is at least substantially a maximum voltage of the energy storage device, and wherein the control signal has a duty cycle that is adaptively adjusted to maintain the output voltage at least substantially constant when the output voltage reaches the third threshold.

6. A device according to claim 1, wherein each enabling signal portion has a pulse width corresponding to at least one cycle of coupling the output to the input and then to the ground.

7. A device according to claim 1, further comprising one of:
a plurality of input switches; and
a plurality of output switches;
wherein the plurality of input switches comprises:
a first input switch configured to couple the input to the energy source; and
at least one second input switch configured to couple the input to a respective at least one second energy source; and
wherein the plurality of output switches comprises:
a first output switch configured to couple the output to the energy storage device; and
at least one second output switch configured to couple the output to a respective at least one second energy storage device.

8. A device according to claim 7, wherein the device comprises the plurality of input switches, and the device further comprising:
a plurality of output switches comprising:
a first output switch configured to couple the output to the energy storage device; and
at least one second output switch configured to couple the output to a respective at least one second energy storage device.

9. A device according to claim 1, wherein the device comprises at least two charging circuits having respective outputs which are coupled together.

10. A device according to claim 1, wherein the switching circuit operates under a first operation mode to alternately couple the output to the input and the ground during the enabling signal portions of the control signal; and isolate the output from the input and the ground during the disabling signal portions of the control signal; and wherein the switching circuit is further configured, under a second operation mode, to alternately couple the input to the output and the ground during the enabling signal portions of the control signal; and to isolate the input from the output and the ground during the disabling signal portions of the control signal.

11. A method of charging an energy storage device, the method comprising:
generating a control signal that includes enabling and disabling signal portions having a duty cycle that is based on a voltage of the energy storage device;
alternately coupling the energy storage device to an energy source and a ground during the enabling signal portions of the control signal; and
isolating the energy storage device from the energy source and the ground during the disabling signal portions of the control signal.

12. A method according to claim 11, wherein the control signal has a first duty cycle when the voltage of the energy storage device is lower than a first threshold, and a second duty cycle when the voltage of the energy storage device is higher than the first threshold.

13. A method according to claim 12, wherein the control signal has the second duty cycle when the voltage of the energy storage device is higher than the first threshold and lower than a second threshold, and a third duty cycle when the voltage of the energy storage device is higher than the second threshold and lower than a third threshold.

14. A method according to claim 13, wherein the third threshold is at least substantially a maximum voltage of the energy storage device, and wherein the control signal has a duty cycle that is adaptively adjusted to maintain the output voltage at least substantially constant when the voltage of the energy storage device reaches the third threshold.

15. A method according to claim 11, wherein each enabling signal portion has a pulse width corresponding to at least one cycle of coupling the energy storage device to the energy source and then to the ground.

16. A method according to claim 11, wherein the energy source is at least one energy source selectable from a plurality of energy sources.

17. A method according to claim 16, wherein the energy storage device is at least one energy storage device selectable from a plurality of energy storage devices.

18. A method according to claim 11, wherein the energy storage device is at least one energy storage device selectable from a plurality of energy storage devices.

19. A method according to claim 11, wherein the energy source outputs at least one of a voltage and a current, and the energy storage device receives at least one of a voltage and a current.

20. A method according to claim 11, wherein alternately coupling the energy storage device to an energy source and a ground during the enabling signal portions of the control signal; and isolating the energy storage device from the energy source and the ground during the disabling signal portions of the control signal are performed under a first operation mode; and wherein the method, under a second operation mode, further comprises:
alternately coupling the energy source to the energy storage device and the ground during the enabling signal portions of the control signal; and
isolating the energy source from the energy storage device and the ground during the disabling signal portions of the control signal.
